(19) United States
(12) Patent Application Publication
(10) Pub. No.: US 2011/0055230 A1
(43) Pub. Date: Mar. 3, 2011

(54) Community-Based Knowledge Sharing

(75) Inventors: Paul C. Castro, Cambridge, MA (US); Yun-Wu Huang, Hawthorne, NY (US); Gegi Thomas, Hawthorne, NY (US)

(73) Assignee: INTERNATIONAL BUSINESS MACHINES CORPORATION, Armonk, NY (US)

(21) Appl. No.: 12/550,031

(22) Filed: Aug. 28, 2009

(51) Int. Cl. G06F 17/30; G06F 15/16

(52) U.S. Cl. 707/751; 709/206; 707/E17.014; 707/E17.032; 707/780

(57) ABSTRACT

A method of intelligent community-based knowledge sharing includes receiving a query from a user of a community, retrieving a social distance hierarchy of members of the community associated with the user, traversing the social distance hierarchy to determine a first recipient of the query, and transmitting the query to the first recipient.

### BACKGROUND OF THE INVENTION

1. Field of the Invention

This application relates to community-based knowledge sharing, and in particular, to intelligent routing and response composition in community-based knowledge sharing with mobile devices.

2. Background

Community-based knowledge sharing is becoming increasingly important as individuals become more mobile. For example, as individuals of a particular group or company perform tasks away from a typical work environment, it becomes difficult to share knowledge using conventional methods. If an individual has a question related to a particular area, and the individual is separated from the work environment, it may take a plurality of phone calls, emails, or other communications before the question may be accurately answered. For example, FIG. 1 depicts such a conventional example.

FIG. 1 is a diagram representing a group of mobile individuals. As illustrated, group or system 100 includes a plurality of individual users 101-106. The plurality of individuals 101-106 may be in active or passive communication facilitated through network 110. As an example, if any one of the plurality of users 101-106 has a particular question, said user may issue a phone call, or message, to another user in an attempt to gain a response answering the question. It follows that if the initial recipient of the question does not respond, the questioning individual may necessarily attempt contacting another individual until all known co-workers are exhausted.

Thus, it may be beneficial to provide enhancements to typical mobile professional knowledge sharing methods to increase access to necessary information.

### SUMMARY

A method of intelligent community-based knowledge sharing in accordance with an exemplary embodiment is provided. The method includes receiving a question of a user of a community, retrieving a social distance hierarchy of members of the community associated with the user, traversing the social distance hierarchy to determine a first recipient of the question, and transmitting the question to the first recipient. The social distance hierarchy is a hierarchy of members of the community associated with the user and is a linked-hierarchy based on social distance of each of the members to the user.

A system of intelligent community-based knowledge sharing according to an example embodiment includes a router configured to route a query from a user of a community to a first recipient within the community, and a knowledge composition engine in communication with the router, and configured to augment an answer received from the first recipient and to format the augmented answer based on a format of the query.

A computer readable storage medium according to an example embodiment includes computer executable instructions that, when executed on a computer processor, direct the computer processor to perform a method of intelligent community-based knowledge sharing. The method includes receiving a query from a user of a community, retrieving a social distance hierarchy of members of the community associated with the user, wherein the social distance hierarchy is a hierarchy of members of the community associated with the user and is a linked-hierarchy based on social distance of each of the members to the user, traversing the social distance hierarchy to determine a first recipient of the query, and transmitting the query to the first recipient.

### BRIEF DESCRIPTION OF THE SEVERAL VIEWS OF THE DRAWINGS

FIG. 1 is a diagram representing a group of mobile individuals;

FIG. 2 is a diagram of an example knowledge sharing system, according to an example embodiment;

FIG. 3 is a diagram of an example knowledge sharing system, according to an example embodiment;

FIG. 4 is a method of knowledge sharing, according to an example embodiment;

FIG. 5 is a method of knowledge sharing, according to an example embodiment;

FIG. 6 is a method of knowledge sharing, according to an example embodiment;

FIG. 7 is a method of knowledge sharing, according to an example embodiment;

FIG. 8 is a method of knowledge sharing, according to an example embodiment; and

FIG. 9 is a computing apparatus, according to an example embodiment.

### DETAILED DESCRIPTION

Detailed illustrative embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments will be described with reference to the attached drawings.

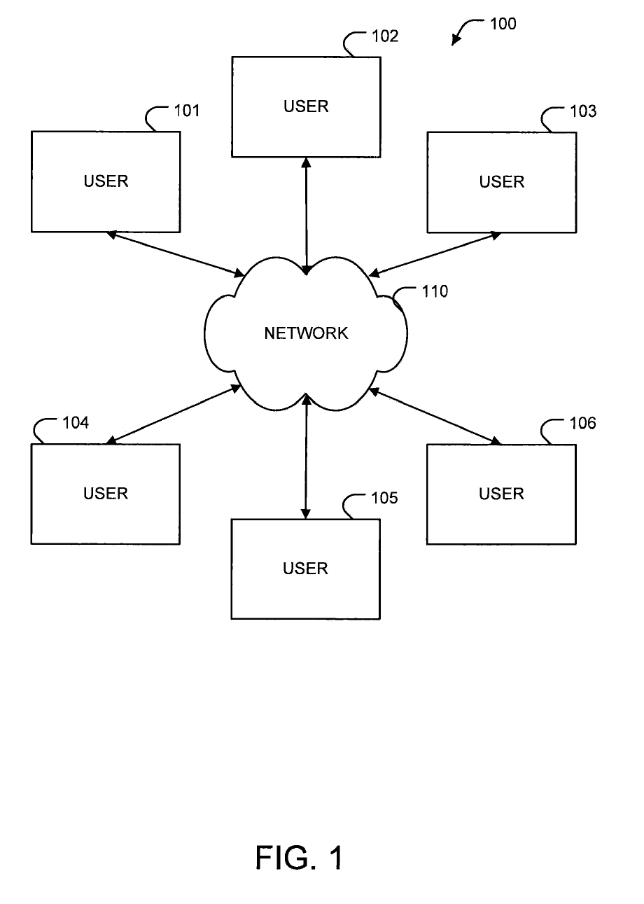

As illustrated and discussed above with regards to FIG. 1, group 100 does not include any intervening client to facilitate accurate and timely responses. Thus, any individual user issuing a question must attempt contact with a plurality of individuals to facilitate an accurate response. According to example embodiments of the present invention, novel methods and systems are provided to overcome these deficiencies.

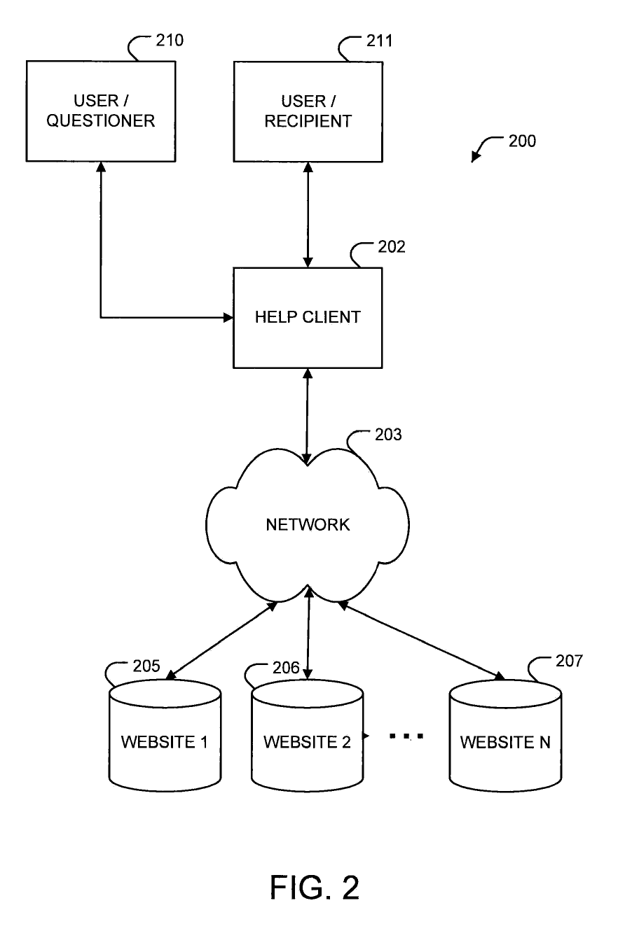

FIG. 2 is a diagram of an example knowledge sharing system, according to an example embodiment. As illustrated, the system 200 includes a plurality of users 210 and 211. Each user of the plurality of users may be a questioner, a question recipient, or a combination of both. For ease of understanding, user 210 represents a questioner and user 211 represents a question recipient, with the understanding that any other combination may be suitable. User 210 and user 211 may be in active or passive communication with each other through a network (not illustrated), through help client 202, or any combination of the network and help client 202. User 210 and user 211 are also each in communication with the help client 202 individually.

The help client 202 represents a client application running on a computer processor, including question/answer storage. The help client 202 coordinates question receipt, routing, response acquisition, and response formatting in system 200. The help client 203 may be in communication with a plurality of websites or website servers 205-207. The communication may be facilitated through a network 203, or through direct communication if suitable. The help client 202 may store and process information related to each of users 210 and 211. For example, this information may include technical areas of interest, website affiliations, usernames, and any other suitable identifying information. The help client 202 may also represent each of users 210 and 211 with a single username such that any question requests for any connected user may include a single username that can be identified to a particular user, used to retrieve website usernames for said particular user, and used to route questions based on information for each website affiliated with said particular user.

For example, user 211 may be affiliated with the plurality of websites 205-207. The plurality of websites 205-207 may be knowledge sharing websites, social networking websites, or any other website. Using information stored pertaining to user 211, the help client 202 may identify user 211 for routing purposes based on received questions from user 210. The routing may be facilitated though social networking distance or social distance between users 210 and 211.

Social distance may be calculated through communication frequency, semantic analysis of related technical areas/communications, and other suitable parameters acquired or inferred through associations with the plurality of websites 205-207 or information stored at the help client 202.

The routing may include directing a question from user 210 to user 211, and directing a response/answer from user 211 to user 210 after processing and response composition steps are performed by the help client 202.

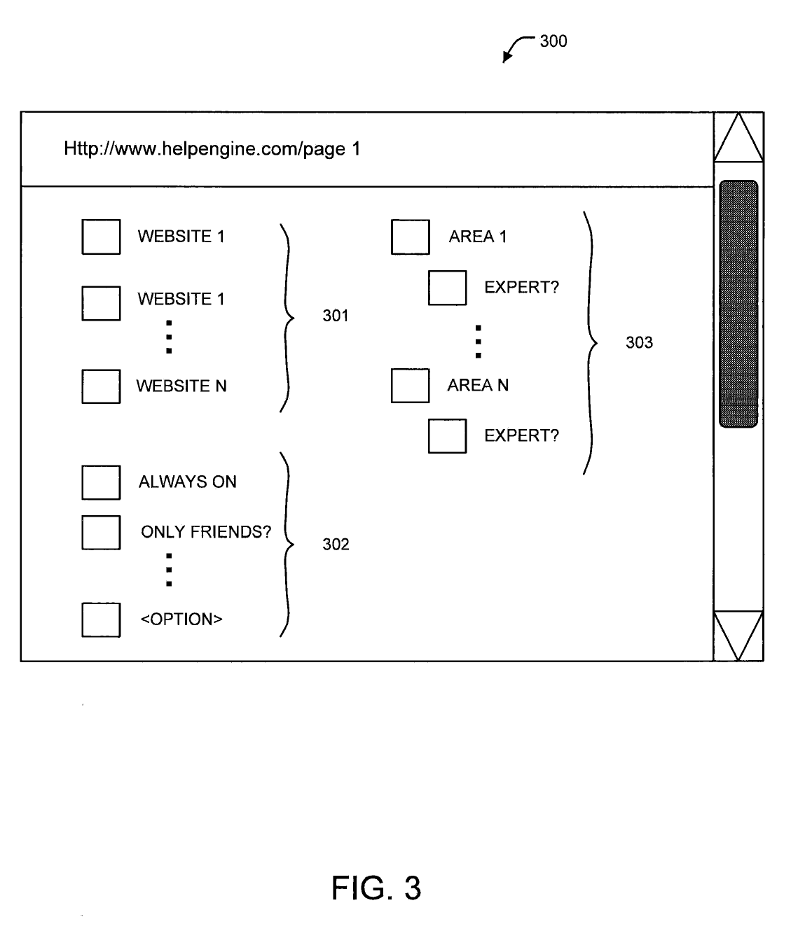

Turning to FIG. 3, a knowledge sharing user interface of help client 202 is illustrated. The interface 300 may include a plurality of information and/or options to identify a user and provide knowledge sharing resources. For example, the interface may include a website affiliation section 301 such that a user may provide website affiliations for interpretation by the help client 202. Although not illustrated, the website affiliation portion may further include selectable, configurable, or text box areas for each website affiliation such that a user may provide username information or other suitable information pertaining to affiliated websites.

The interface 300 may further include a status configuration portion 302. The status configuration portion 302 may provide for selection of a plurality of status options for a user. For example, a user may elect to be contacted by any user at any time. Alternatively, a user may select to be contacted only by friends within a particular group or social distance. The status configuration portion 302 may further include any other suitable status configuration option. Furthermore, actual user status may be facilitated through “presence” services facilitated by the help client 202. For example, if a user is actively or passively communicating with the help client 202, the user's presence may indicate an active user available to answer questions. This presence feature may be useful in the recipient determining portions of methods described later in the present application.

The interface 300 may further include a technical area selection portion 303. For example, the technical area selection portion may include user selectable technology areas. Each selectable technology area may further include options as to level of expertise. For example, as illustrated, each selectable technology area includes an option to select if a user is an expert in a particular technology area. Although not illustrated, additional levels of expertise may be selectable. For example, there may be additional levels such as a number of years within a particular area, university degree level within an area, or any other suitable level of expertise option.

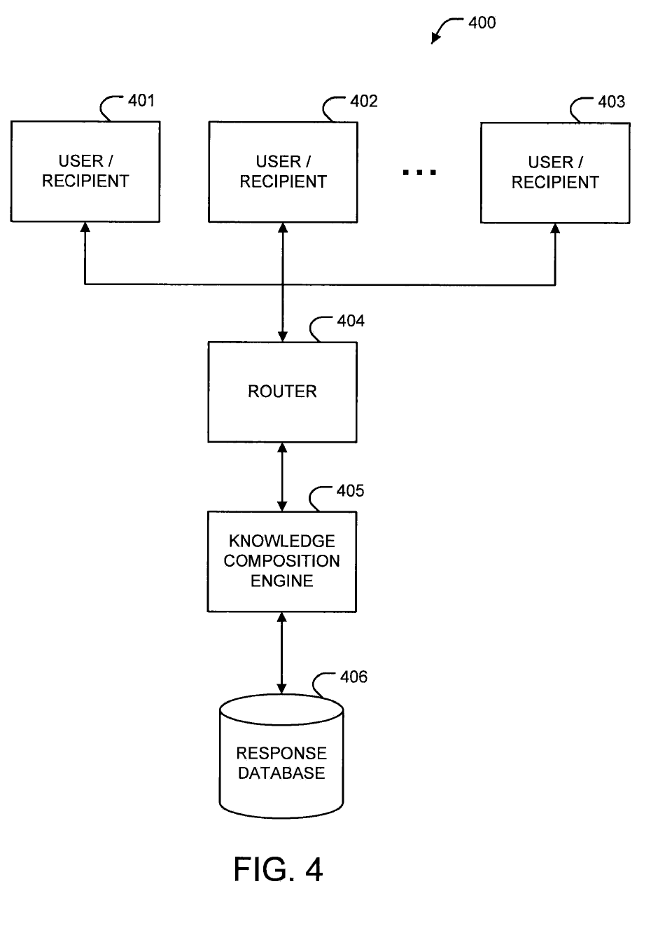

Using the information gathered through interface 300, the help client 202 may route questions in the provided knowledge sharing systems effectively. Turning to FIG. 4, a more detailed example of a knowledge sharing system is illustrated.

The system 400 may include a plurality of users/questioners/recipients 401-403. Each of the users 401-403 may be in communication with a question router 404. The question router 404 may be included within a help client, or may be separate. The router 404 may be configured to provide question routing between users 401-403. The system 400 may further include a knowledge composition engine 405 in communication with the router 404. The knowledge composition engine 405 may be configured to compose responses based on answers received from users 401-403. The system 400 may further include response database 406 in communication with knowledge composition engine 405. The response database 406 may store previously submitted/formatted responses for search by the knowledge composition engine 405. The knowledge composition engine may further organize, delete, or alter stored responses on the response database 406 in response to newer answers received from users 401-403.

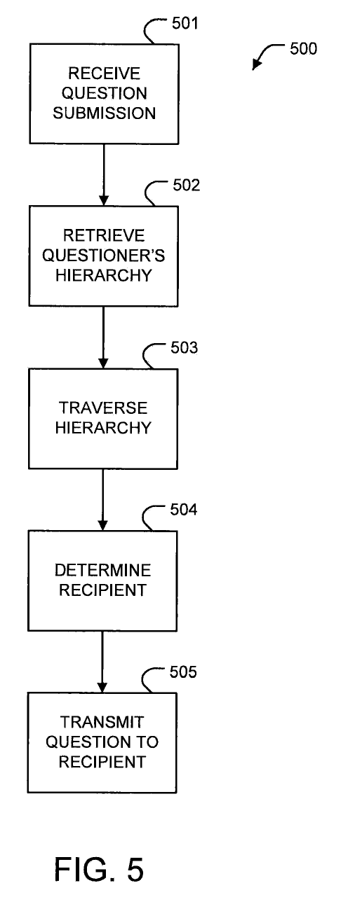

In the system 400, as a question is received from any of the users 401-403, the router 404 may determine an appropriate recipient and forward said question to the recipient. Upon receipt of an answer from the recipient, the router 404 may route the answer to the knowledge composition engine 405. The knowledge composition engine 405 may parse the answer, traverse the response database 406, retrieve stored responses, augment/alter the answer, store any changes, and return the formatted answer to the router 404. The router 404 may route the formatted answer to the questioning user of users 401-403. Hereinafter a more detailed explanation of the methodologies provided by example embodiments is given with reference to FIGS. 5-8.

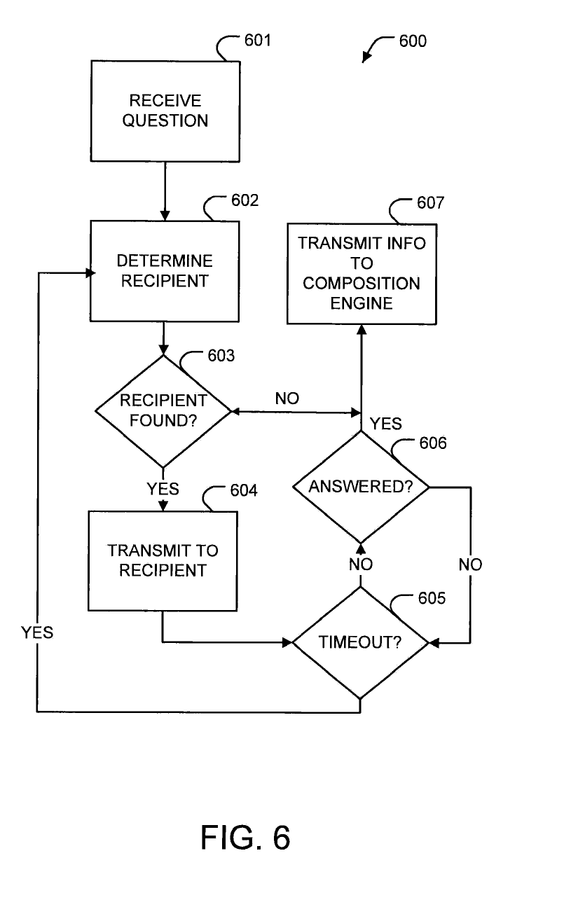

FIG. 5 is a method of knowledge sharing, according to an example embodiment. The method 500 may include receiving a question submission at block 501. The question may be transmitted by a user and received by a router of a help client. In response to the receipt of the question, the method 500 further includes retrieving the questioner's social hierarchy at block 502. For example, a help client may retrieve website/friend/social information for the questioner as stored or retrieved from additional sources. The method 500 may further include traversing the retrieved questioner's hierarchy at block 503. The method 500 may further include determining an appropriate recipient for the received question from the hierarchy at block 504. The appropriate recipient may be determined based on a combination of availability, presence, selected availability options, technical area, level of expertise, and/or social distance. As hierarchies and search trees are relatively known, particulars of these data structures is omitted herein for the sake of brevity. The method 500 may further include transmitting the question to the appropriate recipient. Thus, method 500 provides knowledge sharing routing. Hereinafter, a more detailed explanation of knowledge sharing routing is provided with reference to FIG. 6.

FIG. 6 is a method of knowledge sharing, according to an example embodiment. The method 600 may include receiving a question submission at block 601. The question may be submitted by a user and received at a router of a help client. The method 600 further includes determining a recipient at block 602 (see FIG. 5). If a recipient is not found (603), information pertaining to the received question is transmitted to a composition engine at block 607.

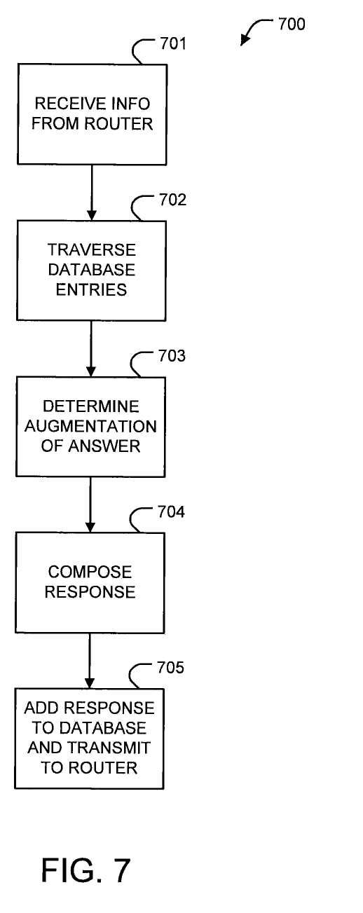

If a recipient is found (603), the received question is transmitted to the located recipient at block 604. If an answer to the question is received (606), the answer and other associated information is transmitted to the knowledge composition engine at block 607. Alternatively, if an answer is not received, for example during an allotted, desired, or preconfigured amount of time (605), the method 600 may include determining another recipient at block 602. If an additional recipient is found, method blocks 603-607 continue as described above for the initial recipient, otherwise, the question information is transmitted to the knowledge composition engine at block 607. Hereinafter, a more detailed explanation of knowledge sharing answer composition methods are described with reference to FIG. 7.

FIG. 7 is a method of knowledge sharing, according to an example embodiment. Method 700 includes receiving information from a router at block 701. For example, the information received may include a question, proposed answer, or other suitable information. The method 700 may further include traversing database entries of a response storage at block 702. For example, a composition engine may parse the received information into logical portions, and use these portions to traverse the response storage. As appropriate previous responses are identified from the traversal, the composition engine may determine an augmentation for the answer at block 703.

For example, a provided answer may be augmented with previously submitted material. Alternatively, the existing answers may be augmented with the newly received material. Thereafter, a response is composed using the augmented answer. The augmenting may be facilitated through intelligent mixing of new answers and previously submitted responses to similar questions. For example, word frequency, synonym matching, indexing, hashing, natural language algorithms, and/or parsing may be used to filter existing entries to the most related or relevant entries. Thereafter, these relevant entries may be parsed and mixed with the newly received response.

In the event no new answer has been submitted, the above described mixing and sorting techniques may be used to locate the most relevant entries to the unanswered question, and these previously stored entries may be mixed to form the response.

Additionally, a syndicated feed of recently answered questions may further facilitate timely responses. For example, newer entries in the response database may be traversed first.

The response may be formatted into a message suited for the questioner's form of question submittal. For example, a question may be submitted over electronic means, or verbal, if desired. If a user submits a question over Short Messaging Service (SMS), the response may be formatted according to SMS standard format, or, 160-character limited message. If the question is received is a different format, the composition engine may format the response accordingly, for example, as an email or other appropriate message.

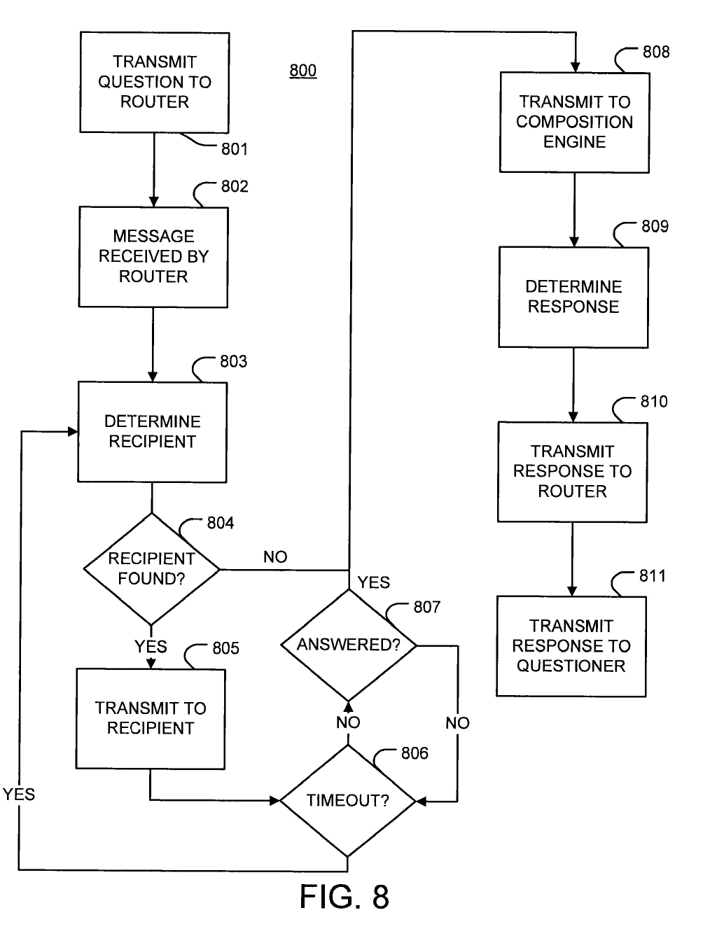

The method 700 further includes adding the composed response to the database (response storage) and transmitting the response to the router at block 705. Hereinafter, a more complete methodology or overview is described with reference to FIG. 8.

FIG. 8 is a method of knowledge sharing, according to an example embodiment. The method 800 includes transmitting a question to a router at block 801. For example, the question may be transmitted by a user of a help client. The message is received by the router at block 802. Thereafter, a recipient is determined by the router at block 803. If a recipient is not found (804), the question and associated information is submitted to the composition engine at block 808.

If a recipient is found (804), the question is transmitted to the recipient at block 805. Thereafter, if the question is answered (807), the answer, question, and associated information is transmitted to the composition engine at block 808. However, if there is a timeout and/or no answer is received (806-807), an attempt to determine an additional recipient occurs at block 803. If an additional recipient is determined, the method continues as described above for blocks 804-808. If no additional recipient is determined, the question and associated information is submitted to the composition engine at block 808.

Upon receipt of the question, answer, and/or associated information, a response is determined at block 809 (see FIG. 7). The response is transmitted to the router at block 810. Finally, the response is transmitted to the questioner at block 811.

Therefore, as described above, systems and methods of community based knowledge sharing are provided herein. The systems and methods provide intelligent routing and formatting of answers to questions submitted by users of a help client system. Questions may be submitted in a variety of formats, however, the use of Text-messaging, mobile email, and/or Short-Messaging Services (SMS) may be particularly useful for mobile individuals.

The systems may include a user, or users, a help client, a router, a composition engine, and a response database. The help client may interpret information relating a user to a number of affiliated websites to develop a social hierarchy between a number of possible question recipients. The help client may route messages through use of the router, compose responses based on received answers and stored answers through the composition engine/response storage.

Additionally, use of the help client system may be advanced through incentive based methods to allow recipients with short answer times, accurate answers, or other suitable criteria to be recognized. In this manner, incentives are provided for other question recipients to answer relayed questions in a timely manner.

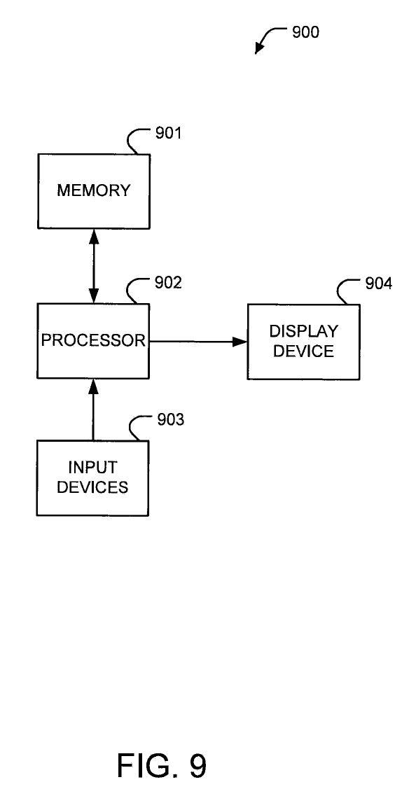

The methods described provide intelligent knowledge sharing. Additionally, the methodologies and systems of example embodiments of the present invention may be implemented in hardware, software, firmware, or a combination thereof. For example, according to an exemplary embodiment, the methodologies described hereinbefore may be implemented by a computer system or apparatus. For example, FIG. 9 illustrates a computer apparatus, according to an exemplary embodiment. Therefore, portions or the entirety of the methodologies described herein may be executed as instructions in a processor 902 of the computer system 900. The computer system 900 includes memory 901 for storage of instructions and information, input device(s) 903 for computer communication, and display device 904. Thus, the present invention may be implemented, in software, for example, as any suitable computer program on a computer system somewhat similar to computer system 900. For example, a program in accordance with the present invention may be a computer program product causing a computer to execute the example methods described herein.

The computer program product may include a computer-readable medium having computer program logic or code portions embodied thereon for enabling a processor (e.g., 902) of a computer apparatus (e.g., 900) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks, cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof Therefore, it is intended that the invention not be limited the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

What is claimed is:

1. A method of intelligent community-based knowledge sharing, comprising:
receiving a query from a user of a community;
retrieving a social distance hierarchy of members of the community associated with the user, wherein the social distance hierarchy is a hierarchy of members of the community associated with the user and is a linked-hierarchy based on social distance of each of the members to the user;
traversing the social distance hierarchy to determine a first recipient of the query; and
transmitting the query to the first recipient.

2. The method of claim 1, wherein retrieving the social distance hierarchy includes determining communication frequency and communication preferences of the user from websites affiliated with the user, and assembling a linked-hierarchy weighted by heuristically-interpreted communication frequency and communication preferences.

3. The method of claim 1, wherein traversing the social distance hierarchy includes weighing each member of the hierarchy based on subject matter pertaining to the question, and determining the first recipient based on a closest social distance and availability for question answering.

4. The method of claim 1, further comprising receiving an answer from the first recipient related to the received query.

5. The method of claim 4, further comprising formatting the answer to a format associated with a format of the received query, and transmitting the formatted answer to the user.

6. The method of claim 4, further comprising traversing previously received answers related to the received query, combining portions of the previously received answers with the received answer to form an augmented answer, and transmitting the augmented answer to the user.

7. The method of claim 1, wherein if an answer is not received from the first recipient, traversing the social distance hierarchy to determine a second recipient of the question, and transmitting the question to the second recipient.

8. The method of claim 1, wherein if an answer is not received from the first recipient, traversing previously received answers related to the received query, combining portions of the previously received answers based on intelligent parsing of the received query, and transmitting the combined answer to the user.

9. A method of intelligent community-based knowledge sharing, comprising:
receiving a query from a user of a community;
routing the query to a member of the community;
receiving an answer from the member; and
augmenting the answer based on interpretation of the received query, the received answer, and a plurality of stored answers to previously answered queries from the community.

10. The method of claim 9, wherein routing the query includes retrieving a social distance hierarchy of members of the community associated with the user, wherein the social distance hierarchy is a hierarchy of members of the community associated with the user and is a linked-hierarchy based on social distance of each of the members to the user, traversing the social distance hierarchy to determine an appropriate member of the community suited to answer the query, and transmitting the query to the member.

11. The method of claim 10, wherein traversing the social distance hierarchy includes weighing each member of the hierarchy based on subject matter pertaining to the question, and determining the first recipient based on a closest social distance and availability for question answering.

12. The method of claim 9, further comprising formatting the augmented answer to a format associated with a format of the received query, and transmitting the formatted answer to the user.

13. The method of claim 9, further comprising traversing newly received answers related to the received query, combining portions of the newly received answers with the received answer, and transmitting the combined answer to the user.

14. The method of claim 9, wherein if an answer is not received from the member, determining a second recipient of the question, and transmitting the query to the second recipient.

15. The method of claim 9, wherein if an answer is not received from the member, traversing previously received answers related to the received query, combining portions of the previously received answers based on intelligent parsing of the received query, and transmitting the combined answer to the user.

16. A system of intelligent community-based knowledge sharing, comprising:
a router configured to route a query from a user of a community to a first recipient within the community; and
a knowledge composition engine in communication with the router, and configured to augment an answer received from the first recipient and to format the augmented answer based on a format of the query.

17. The system of claim 16, further comprising a response database in communication with the knowledge composition engine, and configured to store responses augmented by the knowledge composition engine.

18. The system of claim 17, wherein the knowledge composition engine is configured to retrieve stored responses from the response database in response to the received answer and is further configured to augment the received answer with the retrieved responses.

19. A computer readable storage medium including computer executable instructions that, when executed on a computer processor, direct the computer processor to perform a method of intelligent community-based knowledge sharing, the method comprising:
receiving a query from a user of a community;
retrieving a social distance hierarchy of members of the community associated with the user, wherein the social distance hierarchy is a hierarchy of members of the community associated with the user and is a linked-hierarchy based on social distance of each of the members to the user;
traversing the social distance hierarchy to determine a first recipient of the query; and
transmitting the query to the first recipient.

20. The computer readable storage medium of claim 19, wherein the method further comprises:
receiving an answer from the first recipient; and
augmenting the answer based on interpretation of the received query, the received answer, and a plurality of stored answers to previously answered queries from the community.
